(19) United States
(12) Patent Application Publication
(10) Pub. No.: US 2022/0358264 A1
(43) Pub. Date: Nov. 10, 2022

(54) NATURAL GAS CIRCUIT MODELING METHOD FOR OPERATION CONTROL OF INTEGRATED ENERGY SYSTEM

(71) Applicant: TSINGHUA UNIVERSITY, Beijing (CN)

(72) Inventors: Hongbin SUN, Beijing (CN); Qinglai GUO, Beijing (CN); Bin WANG, Beijing (CN); Binbin CHEN, Beijing (CN); Zhaoguang PAN, Beijing (CN); Yuwei CHEN, Beijing (CN); Xingtao TIAN, Beijing (CN); Wenchuan WU, Beijing (CN)

(21) Appl. No.: 17/865,431

(22) Filed: Jul. 15, 2022

Related U.S. Application Data
(63) Continuation of application No. PCT/CN2021/070699, filed on Jan. 7, 2021.

(30) Foreign Application Priority Data
Jan. 16, 2020 (CN) 202010045108.8

(51) Int. Cl. G06F 30/20

(52) U.S. Cl. CPC G06F 30/20; G06F 2111/10

(57) ABSTRACT

A natural gas circuit modeling method for operation control of an integrated energy system, including: establishing, based on the mass conservation and momentum conservation equations in the natural gas pipeline, as well as the state equation and the flow equation of the natural gas, a partial differential equation between the flow rate and the pressure in the natural gas pipeline; mapping the gas circuit to the frequency domain through Fourier transform and obtaining the lumped parameter model through the two-port equivalence; establishing, combined with the natural gas compressor equation, the general branch model of the natural gas circuit; defining the node-branch correlation matrix and the node-outflow branch correlation matrix to establish the topological constraint equation of the natural gas circuit; and establishing, combined with the general branch model of the natural gas circuit and the topological constraint equation of the natural gas circuit, the natural gas circuit equation.

### CROSS-REFERENCES TO RELATED APPLICATIONS

This application is a continuation of International Application No. PCT/CN2021/070699, filed on Jan. 7, 2021, which is based on and claims priority to Chinese Patent Application No. 202010045108.8, filed on Jan. 16, 2020, titled “NATURAL GAS CIRCUIT MODELING METHOD FOR OPERATION CONTROL OF INTEGRATED ENERGY SYSTEM”, the entire disclosure of which is incorporated herein by reference.

### FIELD

The present disclosure relates to a natural gas circuit modeling method for operation control of an integrated energy system, and belongs to the technical field of operation control of the integrated energy system.

### BACKGROUND

The integrated energy system can effectively improve the comprehensive energy-consuming efficiency, and has become a hot spot and frontier of scientific research and engineering practice at home and abroad. The planning and operation of the integrated energy system is based on the modeling and analysis of each energy network, and the electric power and natural gas energy flows are tightly coupled, in which the analysis of the electric power is based on the simplification from “field” to “circuit”, and a mature circuit theory has been formed, but the analysis of natural gas circuit has not yet formed a unified mature theory. The existing problems in the conventional natural gas circuit modeling include that: it lacks intuitive physical models and poor interpretability; analysis methods for gas-electric coupling networks cannot be unified, and knowledge barriers exist between the two disciplines of electric power and natural gas; and to ensure the accuracy of the solution, it is necessary to introduce a large number of micro-elements in the two dimensions of space and time, which leads to the problem of high computational complexity. In recent years, the modeling idea of “circuit” theory has been gradually applied to natural gas circuit modeling, but a complete and unified theoretical framework has not yet been formed, and it is difficult to solve the model, which is difficult to be further extended to the diversified applications of the planning and operation of the integrated energy system. Therefore, in order to realize the integration of different energy network research disciplines and promote the planning and operation of the integrated energy system, it is urgent to propose a natural gas circuit model that is more suitable for the integrated energy system.

### SUMMARY

The purpose of the present disclosure is to propose a natural gas circuit modeling method for operation control of an integrated energy system, so as to solve the problems existing in the related art. Based on the mass conservation and momentum conservation equations in the natural gas pipeline, as well as the state equation and the flow equation of the natural gas, the partial differential equation between the flow rate and the pressure in the natural gas pipeline is established; the gas circuit is mapped to the frequency domain by Fourier transform and the lumped parameter model through the two-port equivalence is obtained. Combined with the natural gas compressor equation, the general branch model of the natural gas circuit is established; the node-branch correlation matrix and the node-outflow branch correlation matrix are defined to establish the topological constraint equation of the natural gas circuit; and combined with the general branch model of the natural gas circuit and the topological constraint equation of the natural gas circuit, the complete natural gas circuit equation is established.

The natural gas circuit modeling method for operation control of the integrated energy system proposed in the present disclosure includes the following steps:

step 1 of establishing a pipeline model of a natural gas circuit, including:

step 1-1 of establishing a mass conservation equation and a momentum conservation equation for a one-dimensional flow process of the natural gas in the pipeline:

$$\frac{\partial ρ}{\partial t} + \frac{\partial ρ v}{\partial x} = 0 , \\ and \\ \frac{\partial ρ v}{\partial t} + \frac{\partial ρ {v}^{2}}{\partial x} + \frac{\partial p}{\partial x} + \frac{λ ρ {v}^{2}}{2 D} + ρ g sin θ = 0 ,$$

where ρ, v and p denote a density, a flow rate and a pressure of the natural gas, respectively, λ, D and θ denote a friction coefficient, an inner diameter and an inclination angle of the pipeline, respectively, which are provided by a management party of the natural gas circuit, g denotes an acceleration of gravity, and t and x denote time and space, respectively;

step 1-2 of introducing two approximations into the momentum conservation equation in the step 1-1: one approximation is to ignore the convection term, that is

$$\frac{\partial ρ {v}^{2}}{\partial x} \approx 0 ;$$

the other approximation is to perform incremental linearization approximation on the square term of the flow rate in the resistance term: that is v²≈2v_{b}v−v_{b}², where v_{b} denotes a base value of the flow rate of the natural gas in the natural gas pipeline, which is a flow rate in a design condition, to obtain the resistance term

$$\frac{λρ {v}^{2}}{2 D} \approx \frac{λρ ( 2 {v}_{b} v - {v}_{b}^{2} )}{2 D}$$

in the momentum conservation equation in the step 1-1, and simplifying the momentum conservation equation as:

$$\frac{\partial ρ v}{\partial t} + \frac{λρ ( 2 {v}_{b} v - {v}_{b}^{2} )}{2 D} + \frac{\partial p}{\partial x} + ρ g sin θ = 0 ;$$

step 1-3 of substituting a state equation of the natural gas p=RTρ and a flow equation of the pipeline G=ρvA into the mass conservation equation and the simplified momentum conservation equation, and obtaining a space-time partial differential equation between a flow and the pressure of the natural gas in the pipeline:

$$A \frac{\partial p}{\partial t} + R T \frac{\partial G}{\partial x} = 0 , and$$

$$\frac{1}{A} \frac{\partial G}{\partial t} + \frac{\partial p}{\partial x} + \frac{λ {v}_{b} G}{A D} - \frac{λ {v}_{b}^{2} p}{2 R T D} + \frac{p g sin θ}{R T} = 0 ,$$

where R and T denote a gas constant and temperature of the natural gas, respectively, G denotes a mass flow of the natural gas, and A denotes a cross-sectional area of the natural gas pipeline;

step 1-4 of establishing equations of a flow difference and a pressure drop at both ends of a micro-element on the natural gas pipeline:

$$dG = - \frac{A d x}{R T} . \frac{dp}{dt} , and$$

$$dp = - \frac{dx}{A} \cdot \frac{dG}{dt} - \frac{λ {v}_{b} dx}{A D} \cdot G - \frac{2 g D sin θ - λ {v}_{b}^{2}}{2 R T D} dx \cdot p ,$$

step 1-5 of defining, based on the equations of the flow difference and the pressure drop at both ends of the micro-element in the step 1-4, calculation equations of a gas resistance R_{g}, a gas inductance L_{g}, a gas capacitance C_{g} and a controlled gas pressure source k_{g}, in the natural gas pipeline as follows:

R_{g}=λv_{b}/(AD),

L_{g}=1/A,

C_{g}=A/(RT), and

$${k}_{g} = \frac{2 g D sin θ - λ {v}_{b}^{2}}{2 RTD} ,$$

where a pipeline with a length of dx is represented as a gas circuit including four elements, and the entire pipeline is further represented as a distributed parameter gas circuit;

step 1-6 of substituting R_{g}, L_{g}, C_{g} and k_{g} defined in the step 1-5 into the equations of the flow difference and the pressure drop at both ends of the micro-element in the step 1-4, mapping them to a frequency domain through Fourier transform, and obtaining an ordinary differential equation for each frequency component as follows:

$$\frac{dG}{dx} = - j w {C}_{g} \cdot p , and$$

$$\frac{dp}{dx} = - ( {R}_{g} + j w {L}_{g} ) G - {k}_{g} p ,$$

and defining Z_{g}=R_{g}+jwL_{g}, and Y_{g}=jwC_{g};

step 1-7 of using the two equations in the step 1-6 to solve a flow and a pressure at a terminal end of the natural gas pipeline as:

$${G}_{l} = [ - \frac{2 {Y}_{g} {p}_{0}}{\sqrt{{k}_{g}^{2} + 4 {Z}_{g} {Y}_{g}}} sinh ( \frac{\sqrt{{k}_{g}^{2} + 4 {Z}_{g} {Y}_{g}}}{2} l ) + {G}_{0} cosh ( \frac{\sqrt{{k}_{g}^{2} + 4 {Z}_{g} {Y}_{g}}}{2} l ) + \frac{{k}_{g} {G}_{o}}{\sqrt{{k}_{g}^{2} + 4 {Z}_{g} {Y}_{g}}} sinh ( \frac{\sqrt{{k}_{g}^{2} + 4 {Z}_{g} {Y}_{g}}}{2} l ) ] {e}^{- \frac{{k}_{g} l}{2}} ,$$

$$and {p}_{l} = [ {p}_{0} cosh ( \frac{\sqrt{{k}_{g}^{2} + 4 {Z}_{g} {Y}_{g}}}{2} l ) - \frac{2 {k}_{g} {G}_{0}}{\sqrt{{k}_{g}^{2} + 4 {Z}_{g} {Y}_{g}}} sinh ( \frac{\sqrt{{k}_{g}^{2} + 4 {Z}_{g} {Y}_{g}}}{2} l ) - \frac{{k}_{g} {p}_{0}}{\sqrt{{k}_{g}^{2} + 4 {Z}_{g} {Y}_{g}}} sinh ( \frac{\sqrt{{k}_{g}^{2} + 4 {Z}_{g} {Y}_{g}}}{2} l ) ] {e}^{- \frac{{k}_{g} l}{2}} ,$$

where Gₗ and Pₗ denote the flow of the natural gas and the pressure of the natural gas at the terminal end of the natural gas pipeline, respectively, Gₒ and pₒ denote a flow of the natural gas and a pressure of the natural gas at a first end of the natural gas pipeline, respectively, and l denotes a length of the natural gas pipeline;

step 1-8 of defining a propagation coefficient of the natural gas pipeline as γ_{gc}=Z_{g}Y_{g}, and defining a characteristic impedance of the natural gas pipeline as Z_{gc}=Z_{g}/Y_{g};

step 1-9 of expressing, based on the two equations of the flow and the pressure at the terminal end of the natural gas pipeline in the step 1-7 and the two definitions in the step 1-8, the natural gas pipeline equation in a form of a linear two-port network:

$$[ \begin{matrix}{p}_{l} \\ {G}_{l}\end{matrix} ] = [ \begin{matrix}A & B \\ C & D\end{matrix} ] [ \begin{matrix}{p}_{0} \\ {G}_{0}\end{matrix} ] ,$$

where A, B, C and D denote network parameters whose values are:

$$A = [ cosh ( \frac{\sqrt{{k}_{g}^{2} + 4 {γ}_{gc}}}{2} l ) - \frac{{k}_{g}}{\sqrt{{k}_{g}^{2} + 4 {γ}_{gc}}} sinh ( \frac{\sqrt{{k}_{g}^{2} + 4 {γ}_{gc}}}{2} l ) ] \cdot {e}^{- \frac{{k}_{g} l}{2}} ,$$

$$B = - \frac{2}{\sqrt{{k}_{g}^{2} + 4 / {Z}_{g c}}} sinh ( \frac{\sqrt{{k}_{g}^{2} + 4 {γ}_{gc}}}{2} l ) \cdot {e}^{- \frac{{k}_{g} l}{2}} ,$$

$$C = - \frac{2}{\sqrt{{k}_{g}^{2} + 4 {Z}_{g c}}} sinh ( \frac{\sqrt{{k}_{g}^{2} + 4 {γ}_{gc}}}{2} l ) \cdot {e}^{- \frac{{k}_{g} l}{2}} , and$$

$$D = [ cosh ( \frac{\sqrt{{k}_{g}^{2} + 4 {γ}_{gc}}}{2} l ) + \frac{{k}_{g}}{\sqrt{{k}_{g}^{2} + 4 {γ}_{gc}}} sinh ( \frac{\sqrt{{k}_{g}^{2} + 4 {γ}_{gc}}}{2} l ) ] \cdot {e}^{- \frac{{k}_{g} l}{2}} ,$$

step 1-10 of establishing, based on the linear two-port network equation in the step 1-9, a π-type equivalent gas circuit, and equivalent parameters are:

Z=−B

K=1−AD+BC

Y₁=(AD−BC−A)/B, and

Y₂=(1−D)/B;

step 2 of establishing a general branch model of the natural gas circuit, including:

step 2-1 of establishing a mathematical model of a natural gas compressor as follows:

p₁=p₂+E_{g},

where p₁ and p₂ denote pressures on both sides of the natural gas compressor, and E_{g} denotes a pressure increment provided by the natural gas compressor;

step 2-2 of forming, based on the gas resistance, the gas inductance, the gas capacitance, the controlled gas pressure source in the step 1-5 and the natural gas compressor in the step 2-1, a general branch (as shown in FIG. 3), a general branch equation being as follows:

G_{b}=y_{b}(p_{b}+E_{b}−k_{b}p_{f}),

where G_{b} denotes a flow in the branch, G_{b} is an unknown quantity, p_{b} is a gas pressure difference between two ends of the branch, p_{f} is a pressure at a first end of the branch, when the first end of the branch is a gas source, p_{f} is a known quantity, when the first end of the branch is not the gas source, p_{f} is an unknown quantity, pₜ is a pressure at a terminal end of the branch, pₜ is an unknown quantity, y_{b} is a branch admittance composed of the gas resistance, the gas inductance and the gas capacitance, k_{b} and E_{b} denote a component parameter of a controlled gas pressure source in the branch and a component parameter of the natural gas compressor, which are provided by the natural gas circuit management party;

step 2-3 of writing branch equations of all branches in the natural gas circuit into a matrix form as follows:

G_{b}=y_{b}(p_{b}+E_{b}−k_{b}p_{f}),

where G_{b} denotes a vector formed by the flow of each branch, y_{b} denotes a diagonal matrix formed by each branch admittance, p_{b} denotes a vector formed by the pressure difference at both ends of each branch, E_{b} is a vector formed by the pressure increment of each natural gas compressor, k_{b} is a vector formed by the parameter of each controlled gas pressure source, and p_{f} is a vector formed by the gas pressure at the first end of each branch;

step 3 of establishing a topological constraint equation of the natural gas circuit, including:

step 3-1 of defining a node-branch correlation matrix A_{g} in the natural gas circuit, where the matrix is a matrix of n rows and m columns, where n denotes a number of nodes) and m denotes a number of branches, and (A_{g})_{i,j} denotes an element of the i-th row and the j-th column, (A_{g})_{i,j}=0 denotes that a branch j is not connected to a node i, (A_{g})_{i,j}=1 denotes the branch j flowing out from the node i, and (A_{g})_{i,j}=−1 denotes the branch j flowing into the node i;

step 3-2 of defining a node-outflow branch correlation matrix A_{g+} in the natural gas circuit, where the matrix retains an non-negative element in the matrix A_{g}, that is, as for (A_{g})_{i,j}, when the branch j flows out from the node i, the element is 1, and when the branch j does not flow out from the node i, the element is 0;

step 3-3 of establishing a mass conservation equation of nodes of the natural gas circuit:

A_{g}G_{b}=Gₙ,

where Gₙ denotes a column vector formed by a flow injection at each node, where a flow at a gas load node in the natural gas circuit is a known quantity, a flow at a gas source node is an unknown quantity, and a flow at a node of a non-gas load and a non-gas source is 0;

step 3-4 of establishing a gas pressure equation of nodes of the natural gas circuit:

A_{g}^{T}pₙ=p_{b}, and

A_{g+}^{T}pₙ=p_{f},

where pₙ denotes a column vector formed by pressures at each node, where a pressure at the gas source node in the natural gas circuit is a known quantity, a pressure at the gas load node is an unknown quantity, and a pressure at the node of the non-gas load and the non-gas source is an unknown quantity;

step 4 of establishing a natural gas circuit equation, including:

step 4-1 of substituting the equations established in the steps 3-3 and 3-4 into the branch equation established in the step 2-3, and obtaining a natural gas circuit equation in an unreduced form as follows:

Gₙ=A_{g}y_{b}(A_{g}^{T}pₙ+E_{b}−k_{b}A_{g+}^{T}pₙ),

step 4-2 of defining a generalized node admittance matrix Y′_{g} and a generalized node injection vector G′ₙ as follows:

Y′_{g}=A_{g}y_{b}A_{g}^{T}−A_{g}y_{b}k_{b}A_{g+}^{T}, and

G′ₙ=Gₙ−A_{g}y_{b}E_{b};

step 4-3 of substituting Y′_{g} and G′ₙ defined in the step 4-2 into the unreduced natural gas circuit equation in the step 4-1 and obtaining a following natural gas circuit model equation:

Y′_{g}pₙ=G′ₙ,

solving the above natural gas circuit model to obtain an unknown node pressure in the natural gas circuit, and obtaining an unknown branch flow by using the branch equation to implement the operation control of the integrated energy system.

The natural gas circuit modeling method for operation control of the integrated energy system proposed in the present disclosure has the following advantages. The natural gas circuit modeling method for operation control of the integrated energy system of the present disclosure includes: establishing, based on the mass conservation and momentum conservation equations in the natural gas pipeline, as well as the state equation and the flow equation of the natural gas, the partial differential equation between the flow rate and the pressure in the natural gas pipeline; mapping the gas circuit to the frequency domain through Fourier transform and obtaining the lumped parameter model through the two-port equivalence; establishing, combined with the natural gas compressor equation, the general branch model of the natural gas circuit; defining the node-branch correlation matrix and the node-outflow branch correlation matrix to establish the topological constraint equation of the natural gas circuit; and establishing, combined with the general branch model of the natural gas circuit and the topological constraint equation of the natural gas circuit, the natural gas circuit equation. The natural gas circuit modeling method of the present disclosure has a high degree of unity in mathematical form with the network matrix and network equation of the electric power network, thus laying a foundation for the unified analysis of the two heterogeneous energy flows of gas and electricity. Meanwhile, compared with the traditional analysis method, the method of the present disclosure has lower computational complexity.

### BRIEF DESCRIPTION OF DRAWINGS

FIG. 1 is a diagram of a distributed parameter gas circuit of a natural gas pipeline, in which FIG. 1a is a schematic diagram of a distributed parameter gas circuit of the entire natural gas pipeline, and FIG. 1B is a schematic diagram of a distributed parameter gas circuit of a micro-element dx of the natural gas pipeline.

FIG. 2 is a schematic diagram of a lumped parameter equivalent gas circuit of a natural gas pipeline.

FIG. 3 is a schematic diagram of a general branch in a natural gas circuit.

### DESCRIPTION OF EMBODIMENTS

The natural gas circuit modeling method for operation control of an integrated energy system proposed in the present disclosure includes the following steps.

Step 1 of establishing a pipeline model of a natural gas circuit, including:

step 1-1 of establishing a mass conservation equation and a momentum conservation equation for a one-dimensional flow process of the natural gas in the pipeline:

$$\frac{\partial ρ}{\partial t} + \frac{\partial ρ v}{\partial x} = 0 , and$$

$$\frac{\partial ρ v}{\partial t} + \frac{\partial ρ {v}^{2}}{\partial x} + \frac{\partial p}{\partial x} + \frac{λ ρ {v}^{2}}{2 D} + ρ g sin θ = 0 ,$$

where ρ, v and p denote a density, a flow rate and a pressure of the natural gas, respectively, λ, D and θ denote a friction coefficient, an inner diameter and an inclination angle of the pipeline, respectively, which are provided by a management party of the natural gas circuit, g denotes an acceleration of gravity, and t and x denote time and space, respectively;

step 1-2 of introducing two approximations into the momentum conservation equation in the step 1-1: one approximation is to ignore the convection term, that is

$$\frac{\partial ρ {v}^{2}}{\partial x} \approx 0 ;$$

the other approximation is to perform incremental linearization approximation on the square term of the flow rate in the resistance term: that is v²≈2v_{b}v−v_{b}², where v_{b} denotes a base value of the flow rate of the natural gas in the natural gas pipeline, which is a flow rate in a design condition, to obtain the resistance term

$$\frac{λρ {v}^{2}}{2 D} \approx \frac{λρ ( 2 {v}_{b} v - {v}_{b}^{2} )}{2 D}$$

in the momentum conservation equation in the step 1-1, and simplifying the momentum conservation equation as:

$$\frac{\partial ρ v}{\partial t} + \frac{λρ ( 2 {v}_{b} v - {v}_{b}^{2} )}{2 D} + \frac{\partial p}{\partial x} + ρ g sin θ = 0 ;$$

step 1-3 of substituting a state equation of the natural gas p=RTρ and a flow equation of the pipeline G=ρvA into the mass conservation equation and the simplified momentum conservation equation, and obtaining a space-time partial differential equation between a flow and the pressure of the natural gas in the pipeline:

$$A \frac{\partial p}{\partial t} + R T \frac{\partial G}{\partial x} = 0 , and$$

$$\frac{1}{A} \frac{\partial G}{\partial t} + \frac{\partial p}{\partial x} + \frac{λ {v}_{b} G}{A D} - \frac{λ {v}_{b}^{2} p}{2 R T D} + \frac{p g sin θ}{R T} = 0 ,$$

where R and T denote a gas constant and temperature of the natural gas, respectively, G denotes a mass flow of the natural gas, and A denotes a cross-sectional area of the natural gas pipeline;

step 1-4 of establishing equations of a flow difference and a pressure drop at both ends of a micro-element on the natural gas pipeline:

$$dG = - \frac{A d x}{R T} . \frac{dp}{dt} , and$$

$$dp = - \frac{dx}{A} \cdot \frac{dG}{dt} - \frac{λ {v}_{b} dx}{A D} \cdot G - \frac{2 g D sin θ - λ {v}_{b}^{2}}{2 R T D} dx \cdot p ,$$

step 1-5 of defining, based on the equations of the flow difference and the pressure drop at both ends of the micro-element in the step 1-4, calculation equations of a gas resistance R_{g}, a gas inductance Lₛ, a gas capacitance C_{g} and a controlled gas pressure source k_{g}, in the natural gas pipeline as follows:

R_{g}=λv_{b}/(AD),

L_{g}=1/A,

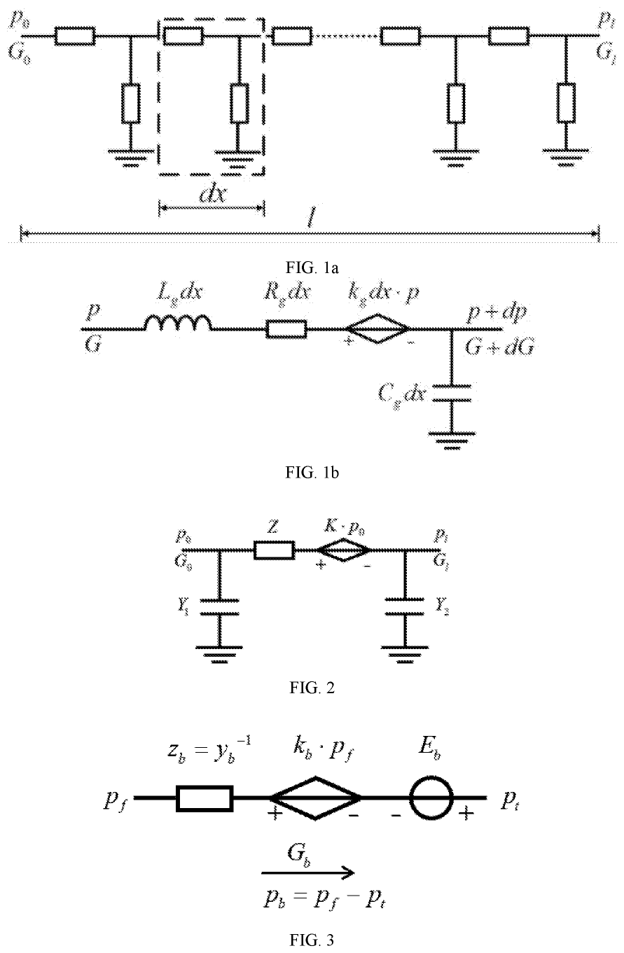

C_{g}=A/(RT), and

$${k}_{g} = \frac{2 g D sin θ - λ {v}_{b}^{2}}{2 RTD} ,$$

where a pipeline with a length of dx is represented as a gas circuit including four elements, and the entire pipeline is further represented as a distributed parameter gas circuit, and the distributed parameter gas circuit of the entire natural gas pipeline and the micro-element dx of the distributed parameter gas circuit of the natural gas pipeline are shown in FIG. 1;

step 1-6 of substituting R_{g}, L_{g}, C_{g} and k_{g} defined in the step 1-5 into the equations of the flow difference and the pressure drop at both ends of the micro-element in the step 1-4, mapping them to a frequency domain through Fourier transform, and obtaining an ordinary differential equation for each frequency component as follows:

$$\frac{dG}{dx} = - j w {C}_{g} \cdot p , and$$

$$\frac{dp}{dx} = - ( {R}_{g} + j w {L}_{g} ) G - {k}_{g} p ,$$

and defining Z_{g}=R_{g}+jwL_{g}, and Y_{g}=jwC_{g};

step 1-7 of using the two equations in the step 1-6 to solve a flow and a pressure at a terminal end of the natural gas pipeline as:

$${G}_{l} = [ - \frac{2 {Y}_{g} {p}_{0}}{\sqrt{{k}_{g}^{2} + 4 {Z}_{g} {Y}_{g}}} sinh ( \frac{\sqrt{{k}_{g}^{2} + 4 {Z}_{g} {Y}_{g}}}{2} l ) + {G}_{0} cosh ( \frac{\sqrt{{k}_{g}^{2} + 4 {Z}_{g} {Y}_{g}}}{2} l ) + \frac{{k}_{g} {G}_{o}}{\sqrt{{k}_{g}^{2} + 4 {Z}_{g} {Y}_{g}}} sinh ( \frac{\sqrt{{k}_{g}^{2} + 4 {Z}_{g} {Y}_{g}}}{2} l ) ] {e}^{- \frac{{k}_{g} l}{2}} ,$$

$$and {p}_{l} = [ \text{} {p}_{0} cosh ( \frac{\sqrt{{k}_{g}^{2} + 4 {Z}_{g} {Y}_{g}}}{2} l ) - \frac{2 {k}_{g} {G}_{0}}{\sqrt{{k}_{g}^{2} + 4 {Z}_{g} {Y}_{g}}} sinh ( \frac{\sqrt{{k}_{g}^{2} + 4 {Z}_{g} {Y}_{g}}}{2} l ) - \frac{{k}_{g} {p}_{0}}{\sqrt{{k}_{g}^{2} + 4 {Z}_{g} {Y}_{g}}} sinh ( \frac{\sqrt{{k}_{g}^{2} + 4 {Z}_{g} {Y}_{g}}}{2} l ) ] {e}^{- \frac{{k}_{g} l}{2}} ,$$

where Gₗ and pₗ denote the flow of the natural gas and the pressure of the natural gas at the terminal end of the natural gas pipeline, respectively, Gₒ and pₒ denote a flow of the natural gas and a pressure of the natural gas at a first end of the natural gas pipeline, respectively, and l denotes a length of the natural gas pipeline;

step 1-8 of defining a propagation coefficient of the natural gas pipeline as γ_{gc}=Z_{g}Y_{g}, and defining a characteristic impedance of the natural gas pipeline as Z_{gc}=Z_{g}/Y_{g};

step 1-9 of expressing, based on the two equations of the flow and the pressure at the terminal end of the natural gas pipeline in the step 1-7 and the two definitions in the step 1-8, the natural gas pipeline equation in a form of a linear two-port network:

$$[ \begin{matrix}{p}_{l} \\ {G}_{l}\end{matrix} ] = [ \begin{matrix}A & B \\ C & D\end{matrix} ] [ \begin{matrix}{p}_{0} \\ {G}_{0}\end{matrix} ] ,$$

where A, B, C and D denote network parameters whose values are:

$$A = [ cosh ( \frac{\sqrt{{k}_{g}^{2} + 4 {γ}_{gc}}}{2} l ) - \frac{{k}_{g}}{\sqrt{{k}_{g}^{2} + 4 {γ}_{gc}}} sinh ( \frac{\sqrt{{k}_{g}^{2} + 4 {γ}_{gc}}}{2} l ] \cdot {e}^{- \frac{{k}_{g} l}{2}} ,$$

$$B = - \frac{2}{\sqrt{{k}_{g}^{2} + 4 / {Z}_{g c}}} sinh ( \frac{\sqrt{{k}_{g}^{2} + 4 {γ}_{g c}}}{2} l ) \cdot {e}^{- \frac{{k}_{g} l}{2}} ,$$

$$C = - \frac{2}{\sqrt{{k}_{g}^{2} + 4 {Z}_{g c}}} sinh ( \frac{\sqrt{{k}_{g}^{2} + 4 {γ}_{g c}}}{2} l ) \cdot {e}^{- \frac{{k}_{g} l}{2}} , and$$

$$D = [ cosh ( \frac{\sqrt{{k}_{g}^{2} + 4 {γ}_{g c}}}{2} l ) + \frac{{k}_{g}}{\sqrt{{k}_{g}^{2} + 4 {γ}_{g c}}} sinh ( \frac{\sqrt{{k}_{g}^{2} + 4 {γ}_{g c}}}{2} l ] \cdot {e}^{- \frac{{k}_{g} l}{2}} ,$$

step 1-10 of establishing, based on the linear two-port network equation in the step 1-9, a π-type equivalent gas circuit as shown in FIG. 2, and equivalent parameters are:

Z=−B,

K=1−AD+BC,

Y₁=(AD−BC−A)/B, and

Y₁=(1−D)/B.

Step 2 of establishing a general branch model of the natural gas circuit, includes:

step 2-1 of establishing a mathematical model of a natural gas compressor as follows:

p₁=p₂+E_{g},

where p₁ and p₂ denote pressures on both sides of the natural gas compressor, and E_{g} denotes a pressure increment provided by the natural gas compressor;

step 2-2 of forming, based on the gas resistance, the gas inductance, the gas capacitance, the controlled gas pressure source in the step 1-5 and the natural gas compressor in the step 2-1, a general branch (as shown in FIG. 3), a general branch equation being as follows:

G_{b}=y_{b}(p_{b}+E_{b}−k_{b}p_{f}),

where G_{b} denotes a flow in the branch, G_{b} is an unknown quantity, which is obtained by solving the natural gas circuit equation to obtain the pressure of each node in the natural gas circuit. p_{b} is a gas pressure difference between two ends of the branch, p_{f} is a pressure at a first end of the branch, when the first end of the branch is a gas source, p_{f} is a known quantity, when the first end of the branch is not the gas source, p_{f} is an unknown quantity, pₜ is a pressure at a terminal end of the branch, pₜ is an unknown quantity, y_{b} is a branch admittance composed of the gas resistance, the gas inductance and the gas capacitance, and k_{b} and E_{b} denote a component parameter of a controlled gas pressure source in the branch and a component parameter of the natural gas compressor, which are provided by the natural gas circuit management party;

step 2-3 of writing branch equations of all branches in the natural gas circuit into a matrix form as follows:

G_{b}=y_{b}(p_{b}+E_{b}−k_{b}p_{f}),

where G_{b} denotes a vector formed by the flow of each branch, y_{b} denotes a diagonal matrix formed by each branch admittance, p_{b} denotes a vector formed by the pressure difference at both ends of each branch, E_{b} is a vector formed by the pressure increment of each natural gas compressor, k_{b} is a vector formed by the parameter of each controlled gas pressure source, and p_{f} is a vector formed by the gas pressure at the first end of each branch.

Step 3 of establishing a topological constraint equation of the natural gas circuit, includes:

step 3-1 of defining a node-branch correlation matrix A_{g} in the natural gas circuit, where the matrix is a matrix of n rows and m columns, where n denotes a number of nodes) and m denotes a number of branches, and (A_{g})_{i,j} denotes an element of the i-th row and the j-th column, (A_{g})_{i,j}=0 denotes that a branch j is not connected to a node i, (A_{g})_{i,j}=1 denotes the branch j flowing out from the node i, and (A_{g})_{i,j}=−1 denotes the branch j flowing into the node i;

step 3-2 of defining a node-outflow branch correlation matrix A_{g+} in the natural gas circuit, where the matrix retains an non-negative element in the matrix A_{g}, that is, as for (A_{g+})_{i,j}, when the branch j flows out from the node i, the element is 1, and when the branch j does not flow out from the node i, the element is 0;

step 3-3 of establishing a mass conservation equation of nodes of the natural gas circuit:

A_{g}G_{b}=Gₙ

where Gₙ denotes a column vector formed by a flow injection at each node, where a flow at a gas load node in the natural gas circuit is a known quantity, a flow at a gas source node is an unknown quantity, and a flow at a node of a non-gas load and a non-gas source is 0;

step 3-4 of establishing a gas pressure equation of nodes of the natural gas circuit:

A_{g}^{T}pₙ=p_{b}, and

A_{g+}^{T}pₙ=p_{f},

where pₙ denotes a column vector formed by pressures at each node, where a pressure at the gas source node in the natural gas circuit is a known quantity, a pressure at the gas load node is an unknown quantity, and a pressure at the node of the non-gas load and the non-gas source is an unknown quantity.

Step 4 of establishing a natural gas circuit equation, includes:

step 4-1 of substituting the equations established in the steps 3-3 and 3-4 into the branch equation established in the step 2-3, and obtaining a natural gas circuit equation in an unreduced form as follows:

Gₙ=A_{g}y_{b}(A_{g}^{T}pₙ+E_{b}−k_{b}A_{g′}^{T}pₙ),

step 4-2 of defining a generalized node admittance matrix Y′_{g} and a generalized node injection vector G′ₙ as follows:

Y′_{g}=A_{g}y_{b}A_{g}^{T}−A_{g}y_{b}k_{b}A_{g+}^{T}, and

G′ₙ=Gₙ−A_{g}y_{b}E_{b};

step 4-3 of substituting Y′_{g} and G′ₙ defined in the step 4-2 into the unreduced natural gas circuit equation in the step 4-1 and obtaining a following natural gas circuit model equation:

Y′_{g}pₙ=G′ₙ,

solving the above natural gas circuit model to obtain an unknown node pressure in the natural gas circuit, and obtaining an unknown branch flow by using the branch equation to implement the operation control of the integrated energy system.

What is claimed is:

1. A natural gas circuit modeling method for operation control of an integrated energy system, comprising:
step 1 of establishing a pipeline model of a natural gas circuit, comprising:
step 1-1 of establishing a mass conservation equation and a momentum conservation equation for a one-dimensional flow process of the natural gas in the pipeline:
$$\frac{\partial ρ}{\partial t} + \frac{\partial ρ v}{\partial x} = 0 , and$$
$$\frac{\partial ρ v}{\partial t} + \frac{\partial ρ {v}^{2}}{\partial x} + \frac{\partial p}{\partial x} + \frac{λ ρ {v}^{2}}{2 D} + ρ g sin θ = 0 ,$$
where ρ, v and p denote a density, a flow rate and a pressure of the natural gas, respectively, λ, D and θ denote a friction coefficient, an inner diameter and an inclination angle of the pipeline, respectively, provided by a management party of the natural gas circuit, g denotes an acceleration of gravity, and t and x denote time and space, respectively;
step 1-2 of introducing two approximations into the momentum conservation equation in the step 1-1: one approximation is to ignore the convection term, that is
$$\frac{\partial ρ {v}^{2}}{\partial x} \approx 0 ;$$
the other approximation is to perform incremental linearization approximation on the square term of the flow rate in the resistance term: that is v²≈2v_{b}v−v_{b}², where v_{b} denotes a base value of the flow rate of the natural gas in the natural gas pipeline, which is a flow rate in a design condition, to obtain the resistance term
$$\frac{λ ρ {v}^{2}}{2 D} \approx \frac{λ ρ ( 2 {v}_{b} v - {v}_{b}^{2} )}{2 D}$$
in the momentum conservation equation in the step 1-1, and simplifying the momentum conservation equation as:
$$\frac{\partial ρ v}{\partial t} + \frac{λ ρ 2 {v}_{b} v - {v}_{b}^{2}}{2 D} + \frac{\partial p}{\partial x} + ρ g sin θ = 0 ;$$
step 1-3 of substituting a state equation of the natural gas p=RTρ and a flow equation of the pipeline G=ρvA into the mass conservation equation and the simplified momentum conservation equation, and obtaining a space-time partial differential equation between a flow and the pressure of the natural gas in the pipeline:
$$A \frac{\partial p}{\partial t} + R T \frac{\partial G}{\partial x} = 0 , and$$
$$\frac{1}{A} \frac{\partial G}{\partial t} + \frac{\partial p}{\partial x} + \frac{λ {v}_{b} G}{A D} - \frac{λ {v}_{b}^{2} p}{2 R T D} + \frac{p g sin θ}{R T} = 0 ,$$
where R and T denote a gas constant and temperature of the natural gas, respectively, G denotes a mass flow of the natural gas, and A denotes a cross-sectional area of the natural gas pipeline;
step 1-4 of establishing equations of a flow difference and a pressure drop at both ends of a micro-element on the natural gas pipeline:
$$dG = - \frac{Adx}{R T} \cdot \frac{dp}{d t} , and$$
$$dp = - \frac{d x}{A} \cdot \frac{dG}{dt} - \frac{λ {v}_{b} dx}{A D} \cdot G - \frac{2 gD sin θ - λ {v}_{b}^{2}}{2 R T D} dx \cdot p ,$$
step 1-5 of defining, based on the equations of the flow difference and the pressure drop at both ends of the micro-element in the step 1-4, calculation equations of a gas resistance R_{g}, a gas inductance L_{g}, a gas capacitance C_{g} and a controlled gas pressure source k_{g}, in the natural gas pipeline as follows:
$${R}_{g} = λ {v}_{b} / ( AD ) ,$$
$${L}_{g} = 1 / A ,$$
$${C}_{g} = A / ( RT ) , and$$
$${k}_{g} = \frac{2 gD sin θ - λ {v}_{b}^{2}}{2 R T D} ,$$
wherein a pipeline with a length of dx is represented as a gas circuit comprising four elements, and the entire pipeline is further represented as a distributed parameter gas circuit;
step 1-6 of substituting R_{g}, L_{g}, C_{g} and k_{g} defined in the step 1-5 into the equations of the flow difference and the pressure drop at both ends of the micro-element in the step 1-4, mapping them to a frequency domain through Fourier transform, and obtaining an ordinary differential equation for each frequency component as follows:
$$\frac{dG}{dx} = - j w {C}_{g} \cdot p , and$$
$$\frac{dp}{dx} = - ( {R}_{g} + {wL}_{g} ) G - {k}_{g} p ,$$
and defining Z_{g}=R_{g}+jwL_{g}, and Y_{g}=jwC_{g};
step 1-7 of using the two equations in the step 1-6 to solve a flow and a pressure at a terminal end of the natural gas pipeline as:
$${G}_{l} = [ - \frac{2 {Y}_{g} {p}_{0}}{\sqrt{{k}_{g}^{2} + 4 {Z}_{g} {Y}_{g}}} sinh ( \frac{\sqrt{{k}_{g}^{2} + 4 {Z}_{g} {Y}_{g}}}{2} l ) + {G}_{0} cosh ( \frac{\sqrt{{k}_{g}^{2} + 4 {Z}_{g} {Y}_{g}}}{2} l ) + \frac{{k}_{g} {G}_{o}}{\sqrt{{k}_{g}^{2} + 4 {Z}_{g} {Y}_{g}}} sinh ( \frac{\sqrt{{k}_{g}^{2} + 4 {Z}_{g} {Y}_{g}}}{2} l ) ] {e}^{- \frac{{k}_{g} l}{2}} , and$$
$${p}_{l} = [ \text{} {p}_{0} cosh ( \frac{\sqrt{{k}_{g}^{2} + 4 {Z}_{g} {Y}_{g}}}{2} l ) - \frac{2 {k}_{g} {G}_{0}}{\sqrt{{k}_{g}^{2} + 4 {Z}_{g} {Y}_{g}}} sinh ( \frac{\sqrt{{k}_{g}^{2} + 4 {Z}_{g} {Y}_{g}}}{2} l ) - \frac{{k}_{g} {p}_{0}}{\sqrt{{k}_{g}^{2} + 4 {Z}_{g} {Y}_{g}}} sinh ( \frac{\sqrt{{k}_{g}^{2} + 4 {Z}_{g} {Y}_{g}}}{2} l ) ] {e}^{- \frac{{k}_{g} l}{2}} ,$$
where Gₗ and pₗ denote the flow of the natural gas and the pressure of the natural gas at the terminal end of the natural gas pipeline, respectively, Gₒ and pₒ denote a flow of the natural gas and a pressure of the natural gas at a first end of the natural gas pipeline, respectively, and l denotes a length of the natural gas pipeline;
step 1-8 of defining a propagation coefficient of the natural gas pipeline as γ_{gc}=Z_{g}Y_{g}, and defining a characteristic impedance of the natural gas pipeline as Z_{gc}=Z_{g}/Y_{g};
step 1-9 of expressing, based on the two equations of the flow and the pressure at the terminal end of the natural gas pipeline in the step 1-7 and the two definitions in the step 1-8, the natural gas pipeline equation in a form of a linear two-port network:
$$[ \begin{matrix}{p}_{l} \\ {G}_{l}\end{matrix} ] = [ \begin{matrix}A & B \\ C & D\end{matrix} ] [ \begin{matrix}{p}_{0} \\ {G}_{0}\end{matrix} ] ,$$
where A, B, C and D denote network parameters whose values are:
$$A = [ cosh ( \frac{\sqrt{{k}_{g}^{2} + 4 {γ}_{gc}}}{2} l ) - \frac{{k}_{g}}{\sqrt{{k}_{g}^{2} + 4 {γ}_{gc}}} sinh ( \frac{\sqrt{{k}_{g}^{2} + 4 {γ}_{gc}}}{2} l ] \cdot {e}^{- \frac{{k}_{g} l}{2}} ,$$
$$B = - \frac{2}{\sqrt{{k}_{g}^{2} + 4 / {Z}_{g c}}} sinh ( \frac{\sqrt{{k}_{g}^{2} + 4 {γ}_{g c}}}{2} l ) \cdot {e}^{- \frac{{k}_{g} l}{2}} ,$$
$$C = - \frac{2}{\sqrt{{k}_{g}^{2} + 4 {Z}_{g c}}} sinh ( \frac{\sqrt{{k}_{g}^{2} + 4 {γ}_{g c}}}{2} l ) \cdot {e}^{- \frac{{k}_{g} l}{2}} , and$$
$$D = [ cosh ( \frac{\sqrt{{k}_{g}^{2} + 4 {γ}_{g c}}}{2} l ) + \frac{{k}_{g}}{\sqrt{{k}_{g}^{2} + 4 {γ}_{g c}}} sinh ( \frac{\sqrt{{k}_{g}^{2} + 4 {γ}_{g c}}}{2} l ] \cdot {e}^{- \frac{{k}_{g} l}{2}} ,$$
step 1-10 of establishing, based on the linear two-port network equation in the step 1-9, a π_type equivalent gas circuit, and equivalent parameters are:
Z=−B,
K=1−AD−BC,
Y₁=(AD−BC−A)/B, and
Y₂=(1−D)/B;
step 2 of establishing a general branch model of the natural gas circuit, comprising:
step 2-1 of establishing a mathematical model of a natural gas compressor as follows:
p₁=p₂+E_{g},
where p₁ and p₂ denote pressures on both sides of the natural gas compressor, and E_{g} denotes a pressure increment provided by the natural gas compressor;
step 2-2 of forming, based on the gas resistance, the gas inductance, the gas capacitance, the controlled gas pressure source in the step 1-5 and the natural gas compressor in the step 2-1, a general branch, a general branch equation being as follows:
G_{b}=y_{b}(p_{b}+E_{b}−k_{b}p_{f}),
where G_{b} denotes a flow in the branch, G_{b} is an unknown quantity, p_{b} is a gas pressure difference between two ends of the branch, p_{f} is a pressure at a first end of the branch, when the first end of the branch is a gas source, p_{f} is a known quantity, when the first end of the branch is not the gas source, p_{f} is an unknown quantity, pₜ is a pressure at a terminal end of the branch, pₜ is an unknown quantity, y_{b} is a branch admittance composed of the gas resistance, the gas inductance and the gas capacitance, k_{b} and E_{b} denote a component parameter of a controlled gas pressure source in the branch and a component parameter of the natural gas compressor, provided by the natural gas circuit management party;
step 2-3 of writing branch equations of all branches in the natural gas circuit into a matrix form as follows:
G_{b}=y_{b}(p_{b}+E_{b}−k_{b}p_{f}),
where G_{b} denotes a vector formed by the flow of each branch, y_{b} denotes a diagonal matrix formed by each branch admittance, p_{b} denotes a vector formed by the pressure difference at both ends of each branch, E_{b} is a vector formed by the pressure increment of each natural gas compressor, k_{b} is a vector formed by the parameter of each controlled gas pressure source, and p_{f} is a vector formed by the gas pressure at the first end of each branch;
step 3 of establishing a topological constraint equation of the natural gas circuit, comprising:
step 3-1 of defining a node-branch correlation matrix A_{g} in the natural gas circuit, wherein the matrix is a matrix of n rows and m columns, where n denotes a number of nodes and m denotes a number of branches, and (A_{g})_{i,j} denotes an element of the i-th row and the j-th column, (A_{g})_{i,j}=0 denotes that a branch j is not connected to a node i, (A_{g})_{i,j}=1 denotes the branch j flowing out from the node i, and (A_{g})_{i,j}=−1 denotes the branch j flowing into the node i;
step 3-2 of defining a node-outflow branch correlation matrix A_{g+} in the natural gas circuit, wherein the matrix retains an non-negative element in the matrix A_{g}, that is, as for (A_{g+})_{i,j}, when the branch j flows out from the node i, the element is 1, and when the branch j does not flow out from the node i, the element is 0;
step 3-3 of establishing a mass conservation equation of nodes of the natural gas circuit:
A_{g}G_{g}=Gₙ,
where Gₙ denotes a column vector formed by a flow injection at each node, where a flow at a gas load node in the natural gas circuit is a known quantity, a flow at a gas source node is an unknown quantity, and a flow at a node of a non-gas load and a non-gas source is 0;
step 3-4 of establishing a gas pressure equation of nodes of the natural gas circuit:
A_{g}^{T}pₙ=p_{b}, and
A^{t}_{g+}pₙ=p_{f},
where pₙ denotes a column vector formed by pressures at each node, where a pressure at the gas source node in the natural gas circuit is a known quantity, a pressure at the gas load node is an unknown quantity, a pressure at the node of the non-gas load and the non-gas source is an unknown quantity;
step 4 of establishing a natural gas circuit equation, comprising:
step 4-1 of substituting the equations established in the steps 3-3 and 3-4 into the branch equation established in the step 2-3, and obtaining a natural gas circuit equation in an unreduced form as follows:
Gₙ=A_{g}y_{b}(A_{g}^{T}pₙ+E_{b}−k_{b}A_{g+}^{T}pₙ),
step 4-2 of defining a generalized node admittance matrix Y′_{g} and a generalized node injection vector G′ₙ as follows:
Y′_{g}=A_{g}y_{b}A_{g}^{T}−A_{g}y_{b}k_{b}A_{g+}^{T}, and
G′ₙ=Gₙ−A_{g}y_{b}E_{b};
step 4-3 of substituting Y′_{g} and G′ₙ defined in the step 4-2 into the unreduced natural gas circuit equation in the step 4-1 and obtaining a following natural gas circuit model equation:
Y′_{g}pₙ=G′ₙ,
solving the above natural gas circuit model to obtain an unknown node pressure in the natural gas circuit, and obtaining an unknown branch flow by using the branch equation to implement the operation control of the integrated energy system.
